(19) United States
(12) Patent Application Publication
(10) Pub. No.: US 2025/0353506 A1
(43) Pub. Date: Nov. 20, 2025

(54) OPERATING AN AUTONOMOUS VEHICLE BASED ON ROAD SURFACE CONDITION

(71) Applicant: Zoox, Inc., Foster City, CA (US)

(72) Inventor: Kenneth Nathan BROWN, San Carlos, CA (US)

(21) Appl. No.: 18/666,040

(22) Filed: May 16, 2024

(51) Int. Cl. B60W 50/00; B60W 60/00; G06T 7/246; G06V 20/56

(52) U.S. Cl. CPC B60W 50/0097; B60W 60/001; G06T 7/248; G06V 20/588; B60W 2050/0022; B60W 2555/20; B60W 2556/40; G06T 2207/10044; G06T 2207/30252

(57) ABSTRACT

A method comprising obtaining weather data relating to an area of an environment, wherein the weather data is associated with a first precipitation rate in the area and is associated with a first time; determining, based at least in part on the weather data, a second precipitation rate at a second time different from the first time and wherein the weather data does not contain the second precipitation rate; determining, based at least in part on the second precipitation rate, a road surface value associated with an amount of precipitation on a surface of a road in the area; and controlling an autonomous vehicle based at least in part on the road surface value.

### BACKGROUND

Vehicles, and especially road-going vehicles, are intended to operate in a range of weather conditions. Users may expect to be able to travel in bright sunlight, in windy conditions, or during a rainstorm. The surface condition of a road, which may be affected by environmental conditions such as rain, may change how a vehicle operates on the road. Rain may also affect the vision of a user and/or an ability of sensors of the vehicle to accurately take readings.

Autonomous or semi-autonomous vehicles use various computing systems to navigate through an environment. The computing systems may process data collected by sensors on the vehicle, where the data may represent an amount of rainwater detected on the windshield or other area of the vehicle.

### BRIEF DESCRIPTION OF DRAWINGS

The detailed description is described with reference to the accompanying figures. The use of the same reference numbers in different figures indicates similar or identical components or features.

FIG. 1 is a pictorial diagram corresponding to a process for determining a surface water value associated with a road in an environment, according to an example.

FIG. 2 is a pictorial diagram corresponding to a process for determining an optical flow field associated with a frame of data, according to an example.

FIG. 3A is a pictorial diagram corresponding to an interpolation process for a frame of weather data based on a determined optical flow field, according to an example.

FIG. 3B is a pictorial diagram corresponding to an interpolation process for a frame of weather data based on a determined optical flow field, according to another example.

FIG. 4 is a pictorial diagram corresponding to an extrapolation process for a frame of weather data based on a single known frame of weather data and a determined optical flow field, according to an example.

FIG. 5 is a flowchart of a method of controlling an autonomous vehicle, according to an example.

FIG. 6 is a block diagram illustrating an example vehicle system discussed herein.

### DETAILED DESCRIPTION

This application relates to procedures, as well as techniques, methods, systems, and computer-readable media for determining a road surface in an environment and controlling an autonomous vehicle based on the same. The techniques described herein may be applied to detect a road surface value associated with precipitation or other material. For example, the techniques may be applied to rain, snow, hail, or sleet and/or to detect dust, sand, or other precipitate or particulate matter that may be present in an environment through which the vehicle is travelling as a result of a weather event, such as a storm. The terms “rain” and “water” are used interchangeably herein to refer to precipitate material as listed above.

Understanding when it is raining, where it is raining, how long it has been raining for, and, where possible, the intensity of the rainfall, may be useful for determining how a vehicle may perform while travelling across a surface, such as a road in a road network, that has been subject to rainfall, and for controlling operation of said vehicle to mitigate for any changes in or to optimize its handling.

Vehicle handling may differ between different surface types, and such handling may be affected by the surface being wet to different extents. For example, light rain may cause only a small change in handling on asphalt as it becomes damp and therefore may cause only a slight change in, e.g., braking distances, whereas heavy rain may cause water to pool on the surface, which may significantly change how the vehicle handles. Similarly, different durations of rain may affect the handling and operation of the vehicle by causing different amounts of water to accumulate on a surface.

In some scenarios, autonomous or semi-autonomous vehicles may incorporate ‘rain sensors’. Rain sensors may utilize reflections of infrared light to determine when water or another liquid is present on a windshield of the vehicle. However, such sensors are typically only useful for detecting liquids or debris on transparent surfaces, and may be unable to accurately differentiate between ongoing rainfall and other liquids on the surface, such as caused by splashes from puddles, limiting their usefulness in the context of autonomous driving. Moreover, rain sensors may require precise and widespread placement, which may not be feasible. Various other types of sensors, such as image sensors, may also be used or adapted for detecting rainfall, but use of such sensors typically results in low accuracy and/or involves complex data processing involving a relatively high processing and/or memory cost, and may also be unable to distinguish between ongoing rainfall and wet environmental conditions. In any case, sensors on a vehicle provide real-time information relating only to that vehicle at that time and do not provide any information relating to where the vehicle may be travelling to and any roads it will use to navigate to its destination.

In other examples, detection of rain and/or surface water on one or more roads may be performed manually by a person who physically visits those roads, makes an estimate of the amount of surface water on said roads, and then reports that estimate back to a control center associated with autonomous vehicles. This approach may be associated with time delays, be imprecise, and be inconsistent between different people who are visiting the roads.

To address these and other issues, the inventor has developed the various techniques described herein that enable surface water conditions on roads to be estimated for current and future points in time based on weather data. This is advantageous because estimated road conditions at future points in time may be used as the basis for controlling operation of an autonomous vehicle within an environment at a current or later time, for example, by re-routing the vehicle along a different, drier route within the environment or by reducing the vehicle's speed or increasing its distance from other vehicles on roads with higher amounts of surface water.

Weather data from radar and/or satellite systems may be relied upon to provide some information in relation to weather conditions in an environment. However, such weather data may only be updated at certain intervals (for example, every 6-8 minutes), rather than being streamed in real-time, accordingly, the weather data for a current point in time may be based on weather data retrieved at the most-recent interval and therefore may be out of date by several minutes. This may cause difficulty in tracking weather events in an environment, especially fast-moving events like storms, and may even cause weather data to appear to jump or skip over areas in an environment, for example portions of a road network, where those portions may be incorrectly determined as not experiencing the weather event. As a result, the skipping-over of such areas may lead to inaccuracies in the estimate of rain experiences in these areas and the estimate of surface water on roads in these areas at current and future points in time, since a future estimation may be based at least in part on a time integration of surface water conditions for an area that was not associated with any weather data (and thus may be incorrectly determined to not have experienced any rainfall) due to the interval between obtaining successive frames of weather data. This, in turn, may lead to sub-optimal operation of autonomous vehicles operating on roads in such areas.

Generally, the solutions described herein use known weather data (“coarse” weather data) at a given point in time as the basis for estimating weather data at another point in time in order to increase the granularity of the weather data and thereby accurately determine a road surface condition associated with the another point in time. Such weather data may be determined through use of radar and similar techniques and may be coarse due to technical limitations and/or the unavailability of compelling use cases that require more fidelity. Estimating weather data in this way provides a smoother transition between frames of weather data over time (“fine” weather data). The estimated weather data for the another point in time may be used, along with weather data for other points in time associated with an area, as the basis for determining surface water conditions in the area at a current or future time, which may directly affect how an autonomous vehicle operates in said area. Consequently, the operation of an autonomous vehicle may be controlled in a more optimal way, such as changing where the autonomous vehicle operates by, for example, changing its route through the road network in the environment or changing its behaviour on particular roads, such as the road associated with the road surface value, by changing its speed, stopping distance, maneuverability, acceleration and/or braking thresholds, limiting steering, and providing an input to a perception module associates with the vehicle in order to change or increase the sensitivity of the autonomous vehicle to splashes from the road surface to thereby reduce false positives. The estimation may be based on weather data associated with a single point in time (and be based on an extrapolation process) or weather data associated with multiple points in time (and be based on an interpolation process when the another point in time is between points in time associated with known data or be based on an extrapolation process when the another point in time is outside a range of time points associated with known data). In either case, the weather data may be projected forwards in order to predict weather data for a point in time in the future. In cases where the weather data is associated with multiple points in time, some weather data may be projected forwards and some weather data may be projected backwards to a single intermediary point in order to predict weather data for that point in time.

In some examples, the weather data obtained from a weather radar may be converted in order to determine a precipitation rate associated with a frame of weather data. For instance, the weather data may contain a reflectivity metric that is converted to a precipitation rate.

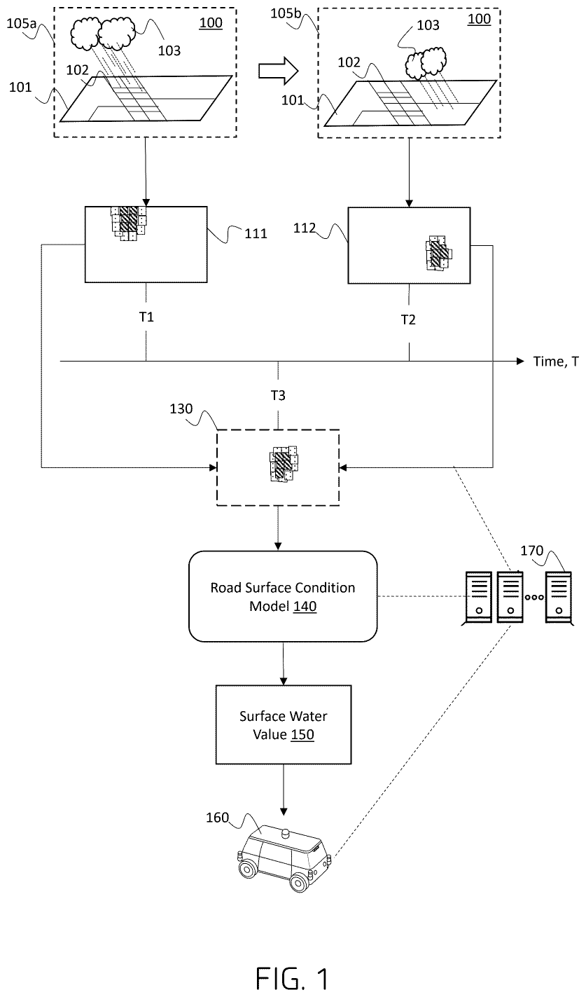

The techniques described herein can be implemented in a number of ways. Example implementations are provided below with reference to the accompanying figures, FIGS. 1-6. Although discussed in the context of an autonomous vehicle, the methods, apparatuses, and systems described herein can be applied to a variety of systems and is not limited to autonomous vehicles. In another example, the techniques can be utilized in an aviation or nautical context. Additionally, the techniques described herein can be used with real data (e.g., captured using sensor(s)), simulated data (e.g., generated by a simulator), or any combination of the two.

FIG. 1 illustrates pictorial representations 105a and 105b of an area 101 of an environment 100 that comprises a road network 102 and a weather event 103, in this case, rain, over a period of time, comprising a time period from T1 to T2. Radar weather data may be captured in relation to the environment 100 and, specifically, the weather event 103. In examples, the radar weather data may be captured by Doppler weather radars, such as the Next Generation Weather Radar (NEXRAD). The captured radar weather data may then be obtained for analysis and/or processing by a computer system 170.

The radar weather data may comprise a first frame 111 associated with a first time T1 and a first rain rate in the area 101 and corresponding to the representation 105a. The radar weather data may further comprise a second frame 112 associated with a second time T2 and a second rain rate in the area 101 and corresponding to the representation 105b. The first and second frames 111, 112 may be associated with a portion of the road network 102. The second time T2 may be later than the first time T1. In some examples, after the weather radar data is obtained it may be rasterized. In addition, a Gaussian blur filter may be applied to smooth uncertainties in dispersion of rain fall.

The first frame 111 may comprise a plurality of pixels, each pixel being associated with a rain rate, where the first rain rate is based at least in part on the rain rate of at least a portion of the pixels in the first frame 111. For example, the first rain rate may be based on the rain rate of at least 20%, 40%, 60%, 80%, 100%, or at least half of the pixels in the first frame 111.

The second frame 112 may comprise a plurality of pixels, each pixel being associated with a rain rate, where the second rain rate is based at least in part on the rain rate of at least a portion of the pixels in the second frame 112. For example, the second rain rate may be based on the rain rate of at least 20%, 40%, 60%, 80%, 100%, or at least half of the pixels in the second frame 112.

In the example of FIG. 1, a subset of the plurality of pixels of the first frame 111 and a subset of the plurality of the pixels of the second frame 112 are depicted. The subset of pixels in the first frame 111 is representative of the rain event 103 occurring in the environment 100 at the first time T1. The subset of pixels in the second frame 112 is representative of the rain event 103 occurring in the environment 100 at the second time, T2. In both frames, the subset of pixels comprises darker (diagonal stripes) and lighter (dots) pixels, where the darker pixels represent a higher rain rate at a corresponding location in the environment 100 than the lower pixels that represent a lower rain rate at a corresponding location in the environment 100. In other examples, the intensity of rain rate may be depicted using different colors, intensities, shades, etc. to represent different rain rates.

The subset of the pixels in the second frame 112 contains fewer dark pixels (corresponding to a smaller area of the environment) which indicates that there are fewer instances of the higher rain rate at time T2 than at time T1 and thus that the rain has a lower intensity at time T2. This is depicted within the representation 105b by smaller rain clouds and fewer lines of rain extending therefrom.

An interpolation process may be performed, by the computer system 170, based at least in part on the first frame 111 and the second frame 112 to determine a third frame 130 associated with a third time T3 and a third rain rate, where the third time T3 is between the first time T1 and the second time T2. The third frame 130 may be representative of a rain rate and its location in the environment 100 at the time T3, where such data was not a part of the weather data that was initially obtained from the radar sensor. The third rain rate may be an estimate of the rain rate within the environment at time T3.

The third rain rate may be input to a road surface condition model 140 that is configured to output a surface water value 150 for the portion of the road network at the third time T3. The surface water value 150 may represent a volume of water (such as standing water) on the portion of the road network.

The road surface condition model 140 may operate based on the following formula:

$$RSC ( t + Δ t ) = RSC ( t ) + DPR ( t ) Δ t - {ET}_{0} ( t ) Δ t - RO ( t ) Δ t \qquad Formula 1$$

$$RO = 1. where RSC ( t ) > 0.5 ; otherwise , RO = 0.$$

ET₀: Potential Evaporation in millimeters per hour (mm/hr)
   DPR: Digital Precipitation Rate (mm/hr)
   RO: Run-Off and Infiltration (mm/hr)
RSC: Road Surface Condition (also referred to as surface water value) (mm)

The Potential Evaporation may correspond to an evaporation rate of water that has fallen onto the road surface. This may be obtained from a weather model and/or estimated based at least in part on temperature or humidity conditions within the area of the environment.

The Digital Precipitation Rate may correspond to the rain rate in the area of the environment in question. For example, the first rain rate associated with the first frame of weather data, which is based on the rain rate of a proportion of pixels within the first frame of weather data. The rain rate may be obtained from or determined based at least in part on the weather data captured by a radar sensor, such as the aforementioned NEXRAD.

The Run-Off and Infiltration may correspond to the rate at which water runs off from a road or infiltrates the road surface, so as to no longer contribute to the amount of water on the surface of the road. This may be obtained from a mathematical model based at least in part on at least one of road composition, road surface angle, or the presence and proximity of one or more drainage points.

The Road Surface Condition is what is output from Formula 1, and is referred to herein as the surface water value that is representative of the amount of surface water on a road at a point in time (t+Δt), which corresponds to T3 in the example of FIG. 1.

An autonomous vehicle 160 may be controlled based at least in part on the surface water value 150. As an example, the computer system 170 may be configured to transmit control data to the autonomous vehicle 160 where the control data was generated based at least in part on the surface water value 150. For instance, the computer system 170 may perform an integration method (such as a cumulative trapezoid function) with respect to the surface water value 150 and other surface water values associated with the same area but at different times in order to estimate a surface water value on a road in the area that is proximal the autonomous vehicle 160, which may be used as the basis for generating the control data.

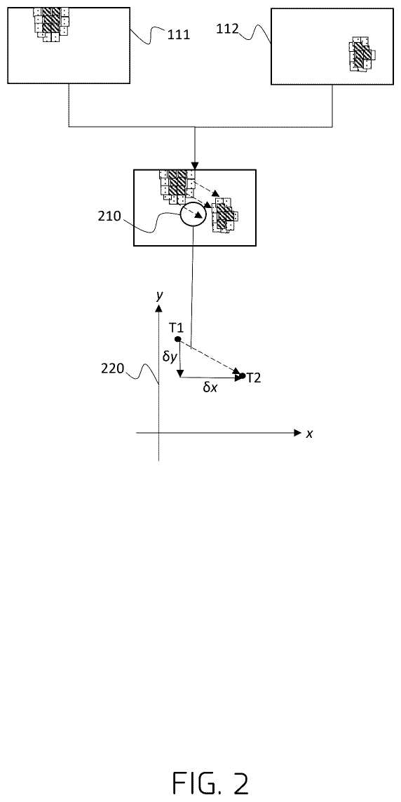

FIG. 2 is a pictorial diagram corresponding to a process for determining an optical flow field associated with a frame of data, according to an example.

An optical flow field 210 may be determined between the first frame 111 and the second frame 112. The optical flow field 210 may be determined on a pixel-by-pixel basis and is depicted by the multiple dashed arrows in FIG. 2. The optical flow field 210 may be representative of the average motion vector of each pixel between the frames and thus the movement of the weather event 103 (that is, the rain) represented in the first frame 111 to its position in the second frame 112. The optical flow field 210 may be determined based at least in part on a difference between the x,y co-ordinates of the weather event 103 between the first and second frames at the respective times T1 and T2, that is, δy and δx. In some examples, the optical flow field may be calculated using a least squares optimization for pixels in the first and second frames, such as the Lucas-Kanade or other methods.

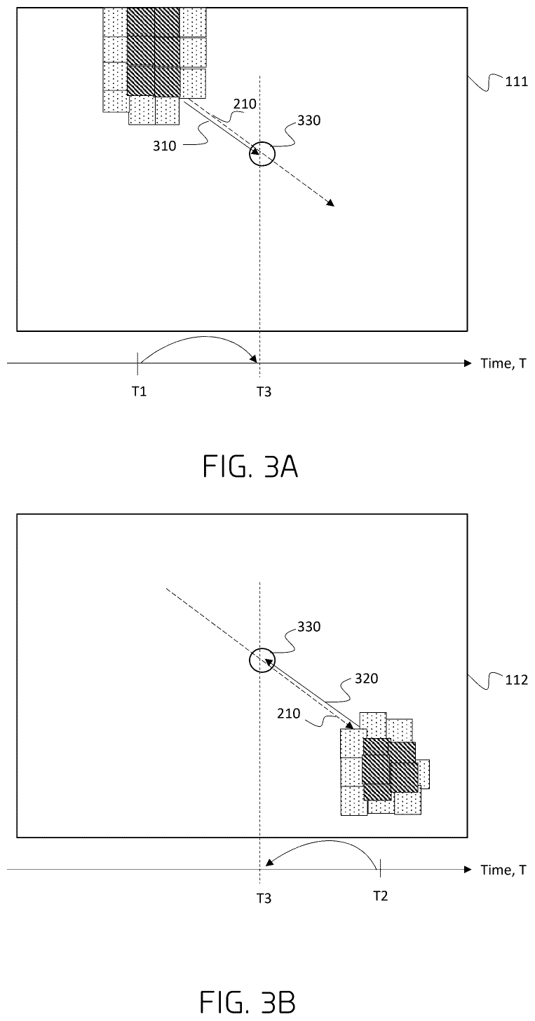

FIG. 3A is a pictorial diagram corresponding to an interpolation process for a frame of weather data based on a determined optical flow field, according to an example.

In the example of FIG. 3A, the frame of weather data is the first frame of weather data 111 described in relation to FIGS. 1 and 2. An optical flow field 210 may be determined using the method described in relation to FIG. 2 and the second frame of weather data 112.

The first frame 111 of weather data may be projected forwards with respect to time until the third time T3, according to the optical flow field 210 (depicted by arrow 310). As a result, a forward projection associated with the third frame (that is, the third frame 130 of FIG. 1) may be generated. The forward projection may comprise the subset of the plurality of pixels in the first frame 111 that are representative of the weather event 103 projected to point 330 based on the optical flow field 210.

A first weighting may be applied to the first rain rate associated with the first frame 111 to generate the third rain rate. The first weighting may be based at least in part on a first difference between the first time T1 and the third time T3, for example, as the difference between T1 and T3 increases the first weighting decreases, as in a negative linear relationship.

FIG. 3B is a pictorial diagram corresponding to an interpolation process for a frame of weather data based on a determined optical flow field, according to another example. The process described in relation to FIG. 3B may be performed in addition to, and possibly in parallel with, the process described in relation to FIG. 3A, resulting in an overall interpolation process.

In the example of FIG. 3B, the frame of weather data is the second frame of weather data 112 described in relation to FIGS. 1 and 2. The optical flow field 210 may be determined using the method described in relation to FIG. 2 and the first frame of weather data 111 and may be the same optical flow field 210 as that described in relation to FIG. 3A but in reverse.

The second frame 112 of weather data may be projected backwards with respect to time until the third time T3, according to a reverse of the optical flow field 210 (depicted by arrow 320). As a result, a backward projection associated with the third frame (that is, the third frame 130 of FIG. 1) may be generated. The backward projection may comprise the subset of the plurality of pixels in the second frame 112 that are representative of the weather event 103 projected to point 330.

A second weighting may be applied to the second rain rate associated with the second frame 112 to generate the third rain rate. The second weighting may be based at least in part on a second difference in time between the second time T2 and the third time T3. Similar to the first weighting, the second weighting decreases as the second difference in time between T2 and T3 increases.

In an example where the processes described in relation to FIGS. 3A and 3B are both performed, the first and second weightings may be applied to the first rain rate and the second rain rate, respectively, to thereby generate the third rain rate. In addition, the forward projection of FIG. 3A and the backward projection of FIG. 3B may be combined to thereby generate the third frame 130. Where the third time T3 is closer to T1 than T2, the first weighting may be greater than the second weighting, and vice versa. The following table provides examples of the first and second weightings based on the distance of the third time T3 between the first and second times T1 and T2. In this example, the third time T3 may correspond to T1+ΔT or T1+2ΔT. In other examples, the third time T3 may correspond to any time between T1 and T2 and the first and second weightings may be altered accordingly.

TABLE 1

| Frame time | A₀ (first frame weighting) | A₁ (second frame weighting) |
|---|---|---|
| T1 | 1.0 | 0.0 |
| T1 + ΔT | 0.67 | 0.33 |
| T1 + 2ΔT | 0.33 | 0.67 |
| T2 | 0.0 | 1.0 |

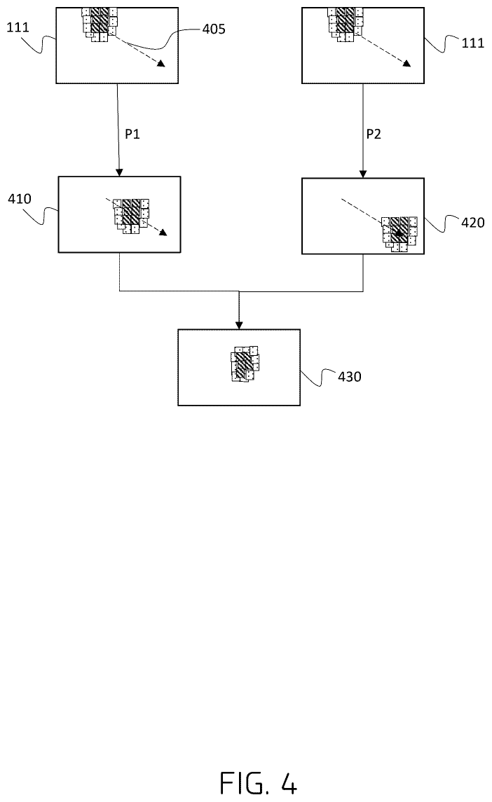

FIG. 4 is a pictorial diagram of an extrapolation process for a frame of weather data based on a single known frame of weather data, in this example frame 111, and a determined optical flow field (depicted by a dashed line 405) associated with said frame, according to an example. The determined optical flow field 405 may be determined based on the optical flow field between the frame 111 and one or more other frames of data associated with one or more times occurring before the first time T1. The process described in relation to FIG. 4 may be performed as part of an estimation of future weather conditions (for example, a second precipitation rate) at a future point in time, that is, at a time that is later than the first time T1 associated with the first frame, based on known weather data associated with an earlier point(s) in time.

Starting from the first frame 111, a first perturbation P1 may be applied to the optical flow field. A first version 410 of a second precipitation rate may then be generated based at least in part on the application of the first perturbation P1.

Again, starting from the first frame 111, a second perturbation P2 may be applied to the optical flow field. Then, a second version 420 of the second precipitation rate may be generated based at least in part on the application of the second perturbation P2.

The first and second versions 410 and 420 may be combined to determine a single precipitation rate (represented in FIG. 4 by 430) associated with the future point in time. In other examples, multiple versions of the second precipitation rate may be determined by applying respective multiple different velocities to the first frame 111. The second precipitation rate may be generated by determining an average, such as a mean, of the multiple versions.

The first and second perturbations may comprise at least one of the following: a perturbation of the intensity of the first precipitation rate, a perturbation of the optical flow field (such as its velocity, distance between corresponding pixels, a number of time steps applied to the optical flow field, and or a periodicity between steps).

The first and second perturbations may be determined using a probabilistic ensemble forecasting technique that provides a range of possible future states of the first frame 111 based at least in part on Monte Carlo analysis.

In other examples, N perturbations may be applied to the optical flow field and an average taken of the resultant N versions of precipitation rates in order to determine a single average precipitation rate for a future (estimated) frame of weather data.

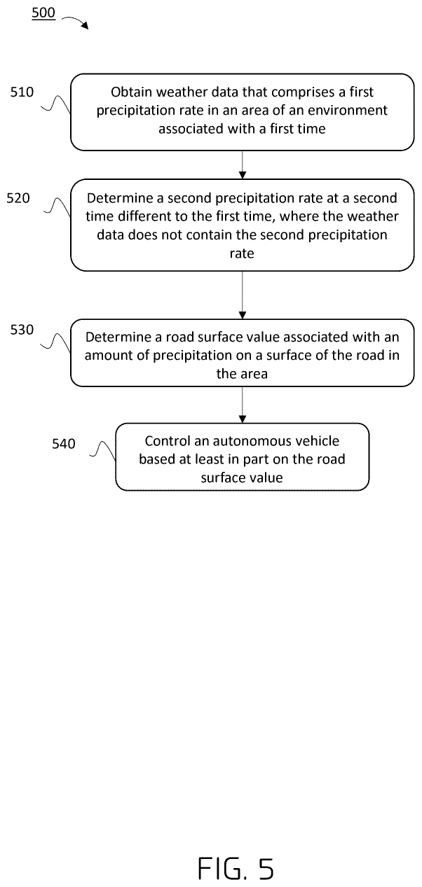

FIG. 5 is a flowchart of a method 500 of controlling an autonomous vehicle, according to an example. The method may be carried out by the computing system 170 described in relation to FIG. 1.

At step 510, weather data relating to an area of an environment may be obtained. The weather data may comprise a first precipitation rate in the area associated with a first time. A precipitation rate may be a quantitative value representative of the amount or intensity of precipitation at a given time.

At step 520, a second precipitation rate at a second time different from the first time may be determined based at least in part on the weather data, where the weather data does not contain the second precipitation rate data. The determination may comprise the determination of an optical flow field associated with the first time. The optical flow field may be determined as described in relation to FIG. 2. In some examples, the determination of step 520 may comprise extrapolation from known data to provide an estimate of (unknown) weather data at a future point in time. For instance, a second frame associated with the second precipitation rate and the second time may be extrapolated based at least in part on the weather data, where the first and second frames are both associated with a portion of the road network in the area of the environment and the second time is later than the first time.

At step 530, a road surface value may be determined based at least in part on the second precipitation rate, where the road surface value may be associated with an amount of precipitation on a surface of the road in the area. The road surface value may be determined based on Formula 1 described in relation to FIG. 1. In examples where the second time is later than the first time, the road surface value may be an estimate of a quantity of surface water present on the road at a future point in time.

At step 540, an autonomous vehicle may be controlled based at least in part on the road surface value. In examples, map data associated with the autonomous vehicles may be updated based at least in part on the road surface value. The updated map data may then be transmitted to the autonomous vehicle to control an aspect of its operation. For instance, changing where the autonomous vehicle operates by, for example, changing its route through the road network in the environment or changing its behaviour on particular roads, such as the road associated with the road surface value, by changing its speed, stopping distance, maneuverability.

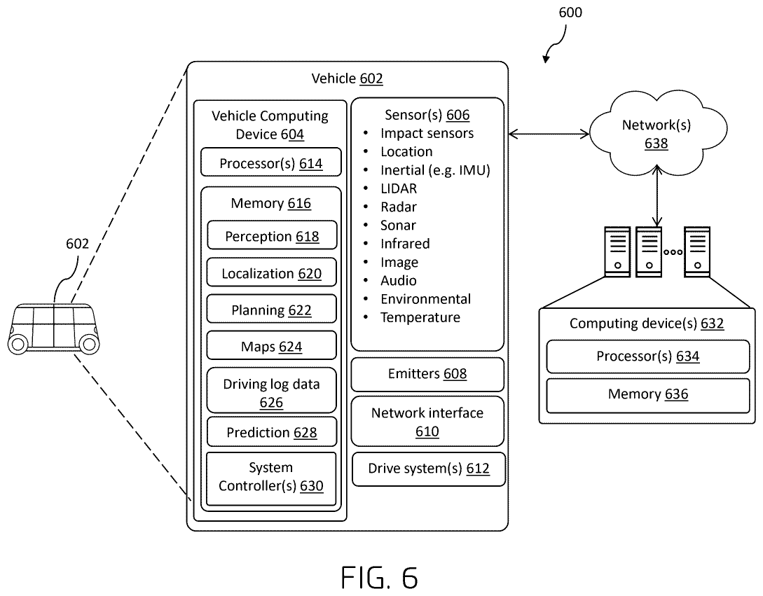

FIG. 6 illustrates a block diagram of an example system 600 that implements the techniques discussed herein. FIG. 6 may represent the vehicle 160 of FIG. 1 and associated computing devices. In some instances, the example system 600 may include a vehicle 602, which may represent the vehicle 160 in FIG. 1. In some instances, the vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 602 may be a fully or partially autonomous vehicle having any other level or classification. Moreover, in some instances, the techniques described herein may be usable by non-autonomous vehicles as well.

The vehicle 602 may include a vehicle computing device(s) 604, sensor(s) 606, emitter(s) 608, network interface(s) 610, and/or drive system(s) 612. Sensor(s) 606 may represent sensor(s) 106. The system 600 may additionally or alternatively comprise computing device(s) 632.

In some instances, the sensor(s) 606 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 606 may include multiple instances of each of these or other types of sensors. For instance, the radar sensors may include individual radar sensors located at the corners, front, back, sides, and/or top of the vehicle 602. As another example, the cameras may include multiple cameras disposed at various locations about the exterior and/or interior of the vehicle 602. The sensor(s) 606 may provide input to the vehicle computing device(s) 604 and/or to computing device(s) 632.

The vehicle 602 may also include emitter(s) 608 for emitting light and/or sound, as described above. The emitter(s) 608 may include interior audio and visual emitter(s) to communicate with passengers of the vehicle 602. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 608 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 602 may also include network interface(s) 610 that enable communication between the vehicle 602 and one or more other local or remote computing device(s) via network(s) 638. The network interface(s) 610 may facilitate communication with other local computing device(s) on the vehicle 602 and/or the drive component(s) 612. The network interface(s) 610 may additionally or alternatively allow the vehicle to communicate with other nearby computing device(s) (e.g., other nearby vehicles, traffic signals, etc.). The network interface(s) 610 may additionally or alternatively enable the vehicle 602 to communicate with computing device(s) 632 over a network 628. In some examples, computing device(s) 632 may comprise one or more nodes of a distributed computing system (e.g., a cloud computing architecture).

The vehicle 602 may include one or more drive components 612. In some instances, the vehicle 602 may have a single drive component 612. In some instances, the drive component(s) 612 may include one or more sensors to detect conditions of the drive component(s) 612 and/or the surroundings of the vehicle 602. By way of example and not limitation, the sensor(s) of the drive component(s) 612 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 612. In some cases, the sensor(s) on the drive component(s) 612 may overlap or supplement corresponding systems of the vehicle 602 (e.g., sensor(s) 606).

The drive component(s) 612 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 612 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 612. Furthermore, the drive component(s) 612 may also include one or more communication connection(s) that enable communication by the respective drive component with one or more other local or remote computing device(s).

The vehicle computing device(s) 604 may include processor(s) 614 and memory 616 communicatively coupled with the one or more processors 614. Computing device(s) 632 may also include processor(s) 634, and/or memory 636. The processor(s) 614 and/or 634 may be any suitable processor capable of executing instructions to process data and perform operations as described herein. By way of example and not limitation, the processor(s) 614 and/or 634 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 616 and/or 636 may be examples of non-transitory computer-readable media. The memory 616 and/or 636 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 616 and/or memory 636 may store a perception component 618, localization component 620, planning component 622, map(s) 624, driving log data 626, prediction component 628, and/or system controller(s) 630-zero or more portions of any of which may be hardware, such as GPU(s), CPU(s), and/or other processing units.

The perception component 618 may detect object(s) in in an environment surrounding the vehicle 602 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 618 is referred to as perception data. The perception component 618 may be configured to associate a bounding region (or other indication) with an identified object. The perception component 618 may be configured to associate a confidence score associated with a classification of the identified object with an identified object. In some examples, objects, when rendered via a display, can be colored based on their perceived class. The object classifications determined by the perception component 618 may distinguish between different object types such as, for example, a passenger vehicle, a pedestrian, a bicyclist, motorist, a delivery truck, a semi-truck, traffic signage, and/or the like.

In at least one example, the localization component 620 may include hardware and/or software to receive data from the sensor(s) 606 to determine a position, velocity, and/or orientation of the vehicle 602 (e.g., one or more of an x-, y-, z-position, roll, pitch, or yaw). For example, the localization component 620 may include and/or request/receive map(s) 624 of an environment and can continuously determine a location, velocity, and/or orientation of the autonomous vehicle 602 within the map(s) 624. In some instances, the localization component 620 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 620 may provide data to various components of the vehicle 602 to determine an initial position of an autonomous vehicle for generating a trajectory and/or for generating map data, as discussed herein. In some examples, localization component 620 may provide, to the perception component 618, a location and/or orientation of the vehicle 602 relative to the environment and/or sensor data associated therewith.

The planning component 622 may receive a location and/or orientation of the vehicle 602 from the localization component 620 and/or perception data from the perception component 618 and may determine instructions for controlling operation of the vehicle 602 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 630 and/or drive component(s) 612 may parse/cause to be carried out, second instructions for the emitter(s) 608 may be formatted according to a second format associated therewith).

The driving log data 626 may comprise sensor data, perception data, and/or scenario labels collected/determined by the vehicle 602 (e.g., by the perception component 618), as well as any other message generated and or sent by the vehicle 602 during operation including, but not limited to, control messages, error messages, etc. In some examples, the vehicle 602 may transmit the driving log data 626 to the computing device(s) 632.

The prediction component 628 may generate one or more probability maps representing prediction probabilities of possible locations of one or more objects in an environment. For example, the prediction component 628 may generate one or more probability maps for vehicles, pedestrians, animals, and the like within a threshold distance from the vehicle 602. In some examples, the prediction component 628 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 622 may be communicatively coupled to the prediction component 628 to generate predicted trajectories of objects in an environment. For example, the prediction component 628 may generate one or more predicted trajectories for objects within a threshold distance from the vehicle 602. In some examples, the prediction component 628 may measure a trace of an object and generate a trajectory for the object based on observed and predicted behavior. Although prediction component 628 is shown on a vehicle 602 in this example, the prediction component 628 may also be provided elsewhere, such as in a remote computing device. In some examples, a prediction component may be provided at both a vehicle and a remote computing device. These components may be configured to operate according to the same or a similar algorithm.

The memory 616 and/or 636 may additionally or alternatively store a mapping system, a planning system, a ride management system, etc. Although perception component 618 and/or planning component 622 are illustrated as being stored in memory 616, perception component 618 and/or planning component 622 may include processor-executable instructions, machine-learned model(s) (e.g., a neural network), and/or hardware.

As described herein, the localization component 620, the perception component 618, the planning component 622, and/or other components of the system 600 may comprise one or more ML models. For example, the localization component 620, the perception component 618, and/or the planning component 622 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,833, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 620 may additionally or alternatively store one or more system controller(s) 630, which may be configured to control steering, propulsion, braking, safety, emitters, communication, and other systems of the vehicle 602. These system controller(s) 630 may communicate with and/or control corresponding systems of the drive component(s) 612 and/or other components of the vehicle 602.

It should be noted that while FIG. 6 is illustrated as a distributed system, in alternative examples, components of the vehicle 602 may be associated with the computing device(s) 632 and/or components of the computing device(s) 632 may be associated with the vehicle 602. That is, the vehicle 602 may perform one or more of the functions associated with the computing device(s) 632, and vice versa.

### Example Clauses

The description contains the following numbered clauses:
1. A system comprising: at least one processor; and at least one non-transitory computer readable medium comprising instructions, that when executed by the at least one processor, cause the system to perform operations comprising: obtaining radar weather data relating to an area of an environment, wherein the area comprises a road network and the radar weather data comprises a first frame associated with a first time and a first rain rate in the area and a second frame associated with a second time and a second rain rate in the area, wherein the first and the second frames are both associated with a portion of the road network in the area of the environment and the second time is later than the first time; performing an interpolation process based at least in part on the first frame and the second frame to thereby determine a third frame associated with a third time and a third rain rate, wherein the third time is between the first time and the second time; inputting the third rain rate into a road surface condition model, wherein the road surface condition model is configured to output a surface water value for the portion of the road network at the third time; and controlling an autonomous vehicle based at least in part on the surface water value.
2. The system of clause 1, wherein the operations further comprise: determining an optical flow field between the first frame and the second frame; projecting, according to the optical flow field, the first frame forwards with respect to time until the third time; generating, based at least in part on the projecting the first frame forwards, a forward projection associated with the third frame; and applying first and second weightings to the first rain rate and the second rain rate respectively, to thereby generate the third rain rate.
3. The system of any preceding clause, wherein the operations further comprise: projecting, according to the optical flow field, the second frame backwards with respect to time until the third time; generating, based at least in part on the projecting the second frame backwards, a backward projection associated with the third frame; and combining the forward projection associated with the third frame and the backward projection associated with the third frame to generate the third frame.
4. The system of any preceding clause, wherein the value of the first weighting is based at least in part on a first difference in time between the first time and the third time and the second weighting is based at least in part on a second difference in time between the second time and the third time.
5. The system of any preceding clause, wherein the first frame and the second frame each comprise a plurality of pixels, each pixel being associated with a rain rate wherein the first rain rate and the second rain rate are based at least in part on the rain rate of a portion of the pixels within the respective frame.
6. A method comprising, obtaining weather data relating to an area of an environment, wherein the weather data is associated with a first precipitation rate in the area and is associated with a first time; determining, based at least in part on the weather data, a second precipitation rate at a second time different from the first time and wherein the weather data does not contain the second precipitation rate; determining, based at least in part on the second precipitation rate, a road surface value associated with an amount of precipitation on a surface of a road in the area; and controlling an autonomous vehicle based at least in part on the road surface value.
7. The method of clause 6, wherein the weather data further comprises a first frame associated with the first precipitation rate and the first time, and the method further comprises: determining, based at least in part on the weather data, a second frame associated with the second precipitation rate and the second time, wherein the first and the second frames are both associated with a portion of a road network in the area of the environment and the second time is later than the first time.
8. The method of clause 6 or 7, further comprising: determining an optical flow field associated with the first frame; and using the optical flow field, as part of the interpolating, to interpolate the second frame.
9. The method of any of clauses 6 to 8, further comprising: determining an optical flow field associated with the first precipitation rate; applying a first perturbation to the optical flow field; generating, based at least in part on the applying a first perturbation to the optical flow field, a first version of the second precipitation rate; applying a second perturbation to the optical flow field; generating, based at least in part on the applying a second perturbation to the optical flow field, a second version of the second precipitation rate; and determining a single precipitation rate associated with the second time based at least in part on the first and second versions of the second precipitation rate.
10. The method of any of clauses 6 to 9, wherein the weather data further comprises a third precipitation rate associated with a third time, wherein the second time is later than the first time and the third time is later than the first time and the second time, and the method further comprises: projecting the third precipitation rate backwards with respect to time until the second time; applying a weighting to the third precipitation rate, wherein the value of the weighting is based at least in part on a difference in time between the third time and the second time; and generating, based at least in part on the applying a weighting to the third precipitation rate, a back projection of the third precipitation rate.
11. The method of any of clauses 6 to 10, further comprising: projecting, the first precipitation rate forwards with respect to time until the second time; applying a weighting to the first precipitation rate, wherein the value of the weighting is based at least in part on a difference in time between the first time and the second time; generating, based at least in part on the applying a weighting to the first precipitation rate, a forward projection of the first precipitation rate; combining the forward projection of the first precipitation rate and the backward projection of the third precipitation rate; and generating, based at least in part on the combining the forward projection and the backward projection, the second precipitation rate.
12. The method of any of clauses 6 to 11, further comprising: updating, based at least in part on the road surface value, map data associated with the autonomous vehicle to thereby generate updated map data; and transmitting the updated map data to the autonomous vehicle.
13. The method of any of clauses 6 to 12, further comprising: obtaining the weather data from a weather radar.
14. One or more non-transitory computer-readable media storing instructions executable by one or more processors, wherein the instructions, when executed, cause the one or more processors to perform operations comprising: obtaining weather data relating to an area of an environment, wherein the weather data is associated with a first precipitation rate in the area and is associated with a first time; determining, based at least in part on the weather data, a second precipitation rate at a second time different from the first time and wherein the weather data does not contain the second precipitation rate; determining, based at least in part on the second precipitation rate, a road surface value associated with an amount of precipitation on a surface of a road in the area; and controlling an autonomous vehicle based at least in part on the road surface value.
15. The one or more non-transitory computer-readable media of clause 14, wherein the weather data further comprises a first frame associated with the first precipitation rate and the first time, and wherein the operations further comprise: determining, based at least in part on the weather data, a second frame associated with the second precipitation rate and the second time, wherein the first and the second frames are both associated with a portion of a road network in the area of the environment and the second time is later than the first time.
16. The one or more non-transitory computer-readable media of clause 14 or 15, wherein the operations further comprise: determining an optical flow field associated with the first frame; and using the optical flow field, as part of the interpolating, to interpolate the second frame.
17. The one or more non-transitory computer-readable media of any of clauses 14 to 16, wherein the operations further comprise: determining an optical flow field associated with the first precipitation rate; applying a first perturbation to the optical flow field; generating, based at least in part on the applying a first perturbation to the optical flow field, a first version of the second precipitation rate; applying a second perturbation to the optical flow field; generating, based at least in part on the applying a second perturbation to the optical flow field, a second version of the second precipitation rate; and determining a single precipitation rate associated with the second time based at least in part on the first and second versions of the second precipitation rate.
18. The one or more non-transitory computer-readable media of any of clauses 14 to 17, wherein the weather data further comprises a third precipitation rate associated with a third time, wherein the second time is later than the first time and the third time is later than the first time and the second time, and wherein the operations further comprise: projecting the third precipitation rate backwards with respect to time until the second time; applying a weighting to the third precipitation rate, wherein the value of the weighting is based at least in part on a difference in time between the third time and the second time; and generating, based at least in part on the applying a weighting to the third precipitation rate, a back projection of the third precipitation rate.
19. The one or more non-transitory computer-readable media of any of clauses 14 to 18, wherein the operations further comprise: projecting, the first precipitation rate forwards with respect to time until the second time; applying a weighting to the first precipitation rate, wherein the value of the weighting is based at least in part on a difference in time between the first time and the second time; generating, based at least in part on the applying a weighting to the first precipitation rate, a forward projection of the first precipitation rate; combining the forward projection of the first precipitation rate and the backward projection of the third precipitation rate; and generating, based at least in part on the combining the forward projection and the backward projection, the second precipitation rate.
20. The one or more non-transitory computer-readable media of any of clauses 14 to 19, wherein the operations further comprise: updating, based at least in part on the road surface value, map data associated with the autonomous vehicle to thereby generate updated map data; and transmitting the updated map data to the autonomous vehicle.

While the example clauses described above are described with respect to one particular implementation, it should be understood that, in the context of this document, the content of the example clauses can also be implemented via a method, device, system, computer-readable medium, and/or another implementation. Additionally, any of examples 1-20 may be implemented alone or in combination with any other one or more of the examples 1-20.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into subcomputations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow charts, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

1. A system comprising:
at least one processor; and
at least one non-transitory computer readable medium comprising instructions, that when executed by the at least one processor, cause the system to perform operations comprising:
obtaining radar weather data relating to an area of an environment, wherein the area comprises a road network and the radar weather data comprises a first frame associated with a first time and a first rain rate in the area and a second frame associated with a second time and a second rain rate in the area, wherein the first and the second frames are both associated with a portion of the road network in the area of the environment and the second time is later than the first time;
performing an interpolation process based at least in part on the first frame and the second frame to thereby determine a third frame associated with a third time and a third rain rate, wherein the third time is between the first time and the second time;
inputting the third rain rate into a road surface condition model, wherein the road surface condition model is configured to output a surface water value for the portion of the road network at the third time; and
controlling an autonomous vehicle based at least in part on the surface water value.

2. The system of claim 1, wherein the operations further comprise:
determining an optical flow field between the first frame and the second frame;
projecting, according to the optical flow field, the first frame forwards with respect to time until the third time;
generating, based at least in part on the projecting the first frame forwards, a forward projection associated with the third frame; and
applying first and second weightings to the first rain rate and the second rain rate respectively, to thereby generate the third rain rate.

3. The system of claim 2, wherein the operations further comprise:
projecting, according to the optical flow field, the second frame backwards with respect to time until the third time;
generating, based at least in part on the projecting the second frame backwards, a backward projection associated with the third frame; and
combining the forward projection associated with the third frame and the backward projection associated with the third frame to generate the third frame.

4. The system of claim 2, wherein the value of the first weighting is based at least in part on a first difference in time between the first time and the third time and the second weighting is based at least in part on a second difference in time between the second time and the third time.

5. The system of claim 1, wherein the first frame and the second frame each comprise a plurality of pixels, each pixel being associated with a rain rate wherein the first rain rate and the second rain rate are based at least in part on the rain rate of a portion of the pixels within the respective frame.

6. A method comprising:
obtaining weather data relating to an area of an environment, wherein the weather data is associated with a first precipitation rate in the area and is associated with a first time;
determining, based at least in part on the weather data, a second precipitation rate at a second time different from the first time and wherein the weather data does not contain the second precipitation rate;
determining, based at least in part on the second precipitation rate, a road surface value associated with an amount of precipitation on a surface of a road in the area; and
controlling an autonomous vehicle based at least in part on the road surface value.

7. The method of claim 6, wherein the weather data further comprises a first frame associated with the first precipitation rate and the first time, and the method further comprises:
determining, based at least in part on the weather data, a second frame associated with the second precipitation rate and the second time, wherein the first and the second frames are both associated with a portion of a road network in the area of the environment and the second time is later than the first time.

8. The method of claim 7, further comprising:
determining an optical flow field associated with the first frame; and
using the optical flow field, as part of the interpolating, to interpolate the second frame.

9. The method of claim 6, further comprising:
determining an optical flow field associated with the first precipitation rate;
applying a first perturbation to the optical flow field;
generating, based at least in part on the applying a first perturbation to the optical flow field, a first version of the second precipitation rate;
applying a second perturbation to the optical flow field;
generating, based at least in part on the applying a second perturbation to the optical flow field, a second version of the second precipitation rate; and
determining a single precipitation rate associated with the second time based at least in part on the first and second versions of the second precipitation rate.

10. The method of claim 6, wherein the weather data further comprises a third precipitation rate associated with a third time, wherein the second time is later than the first time and the third time is later than the first time and the second time, and the method further comprises:
projecting the third precipitation rate backwards with respect to time until the second time;
applying a weighting to the third precipitation rate, wherein the value of the weighting is based at least in part on a difference in time between the third time and the second time; and
generating, based at least in part on the applying a weighting to the third precipitation rate, a back projection of the third precipitation rate.

11. The method of claim 10, further comprising:
projecting, the first precipitation rate forwards with respect to time until the second time;
applying a weighting to the first precipitation rate, wherein the value of the weighting is based at least in part on a difference in time between the first time and the second time;
generating, based at least in part on the applying a weighting to the first precipitation rate, a forward projection of the first precipitation rate;
combining the forward projection of the first precipitation rate and the backward projection of the third precipitation rate; and
generating, based at least in part on the combining the forward projection and the backward projection, the second precipitation rate.

12. The method of claim 6, further comprising:
updating, based at least in part on the road surface value, map data associated with the autonomous vehicle to thereby generate updated map data; and
transmitting the updated map data to the autonomous vehicle.

13. The method of claim 6, further comprising:
obtaining the weather data from a weather radar.

14. One or more non-transitory computer-readable media storing instructions executable by one or more processors, wherein the instructions, when executed, cause the one or more processors to perform operations comprising:
obtaining weather data relating to an area of an environment, wherein the weather data is associated with a first precipitation rate in the area and is associated with a first time;
determining, based at least in part on the weather data, a second precipitation rate at a second time different from the first time and wherein the weather data does not contain the second precipitation rate;
determining, based at least in part on the second precipitation rate, a road surface value associated with an amount of precipitation on a surface of a road in the area; and
controlling an autonomous vehicle based at least in part on the road surface value.

15. The one or more non-transitory computer-readable media of claim 14, wherein the weather data further comprises a first frame associated with the first precipitation rate and the first time, and wherein the operations further comprise:
determining, based at least in part on the weather data, a second frame associated with the second precipitation rate and the second time, wherein the first and the second frames are both associated with a portion of a road network in the area of the environment and the second time is later than the first time.

16. The one or more non-transitory computer-readable media of claim 15, wherein the operations further comprise:
determining an optical flow field associated with the first frame; and
using the optical flow field, as part of the interpolating, to interpolate the second frame.

17. The one or more non-transitory computer-readable media of claim 14, wherein the operations further comprise:
determining an optical flow field associated with the first precipitation rate;
applying a first perturbation to the optical flow field;
generating, based at least in part on the applying a first perturbation to the optical flow field, a first version of the second precipitation rate;
applying a second perturbation to the optical flow field;
generating, based at least in part on the applying a second perturbation to the optical flow field, a second version of the second precipitation rate; and
determining a single precipitation rate associated with the second time based at least in part on the first and second versions of the second precipitation rate.

18. The one or more non-transitory computer-readable media of claim 14, wherein the weather data further comprises a third precipitation rate associated with a third time, wherein the second time is later than the first time and the third time is later than the first time and the second time, and wherein the operations further comprise:
projecting the third precipitation rate backwards with respect to time until the second time;
applying a weighting to the third precipitation rate, wherein the value of the weighting is based at least in part on a difference in time between the third time and the second time; and
generating, based at least in part on the applying a weighting to the third precipitation rate, a back projection of the third precipitation rate.

19. The one or more non-transitory computer-readable media of claim 18, wherein the operations further comprise:
projecting, the first precipitation rate forwards with respect to time until the second time;
applying a weighting to the first precipitation rate, wherein the value of the weighting is based at least in part on a difference in time between the first time and the second time;
generating, based at least in part on the applying a weighting to the first precipitation rate, a forward projection of the first precipitation rate;
combining the forward projection of the first precipitation rate and the backward projection of the third precipitation rate; and
generating, based at least in part on the combining the forward projection and the backward projection, the second precipitation rate.

20. The one or more non-transitory computer-readable media of claim 14, wherein the operations further comprise:
updating, based at least in part on the road surface value, map data associated with the autonomous vehicle to thereby generate updated map data; and
transmitting the updated map data to the autonomous vehicle.
